(19) United States
(12) Patent Application Publication
(10) Pub. No.: US 2010/0064655 A1
(43) Pub. Date: Mar. 18, 2010

(54) SYSTEM AND METHOD FOR MANAGING TURBINE EXHAUST GAS TEMPERATURE

(75) Inventors: Hua Zhang, Greer, SC (US); Saravanan Nattanmai Venkataraman, Chennai Tamilnadu (IN); Joel Donnell Holt, Scotia, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/211,456

(22) Filed: Sep. 16, 2008

(51) Int. Cl. F02C 7/141

(52) U.S. Cl. 60/39.5; 415/116

(57) ABSTRACT

A system for thermal management of exhaust gas includes: a nozzle configured to be disposed in fluid communication with an exhaust of a turbomachine; a mixing conduit in fluid communication with the nozzle; at least one secondary inlet disposed around a periphery of the nozzle and extending between an exterior of the mixing conduit and an interior of the mixing conduit; a variable nozzle mechanism configured to be movable between i) a first position in which the mechanism is configured to close the at least one secondary inlet and ii) a second position in which the mechanism is configured to open the at least one secondary inlet and adjust a selected diameter of the nozzle; and an actuator configured to move the variable nozzle mechanism between the first position and the second position.

### BACKGROUND OF THE INVENTION

The subject matter disclosed herein relates to gas turbines and, more particularly, to methods and systems for managing turbine exhaust.

Gas turbines are commonly used in conjunction with auxialiary systems such as heat recovery steam generators (HRSG) that utilize exhaust from the gas turbine. HRSG systems are useful, for example, in electricity generation. HRSG systems are coupled to an exhaust assembly of gas turbines and are fed hot exhaust therefrom, which is used to generate steam which in turn drives a steam turbine.

During start up of a gas turbine, various components of an associated HRSG, such as the super heater and reheater, are subject to rapid temperature increases. Such increases can cause structural damage to the tubes in the HRSG. Techniques to counteract such rapid temperature increases include slowing down the gas turbine start-up time and using a temperator for fluids inside the tubes, which can compromise output efficiency of the turbine. Accordingly, there is a need for improved systems and methods for managing a temperature of an exhaust of a gas turbine without compromising efficiency.

### BRIEF DESCRIPTION OF THE INVENTION

A system for thermal management of exhaust gas, constructed in accordance with exemplary embodiments of the invention includes: a nozzle configured to be disposed in fluid communication with an exhaust of a turbomachine; a mixing conduit in fluid communication with the nozzle; at least one secondary inlet disposed around a periphery of the nozzle and extending between an exterior of the mixing conduit and an interior of the mixing conduit; a variable nozzle mechanism configured to be movable between i) a first position in which the mechanism is configured to close the at least one secondary inlet and ii) a second position in which the mechanism is configured to open the at least one secondary inlet and adjust a selected diameter of the nozzle; and an actuator configured to move the variable nozzle mechanism between the first position and the second position.

Other exemplary embodiments of the invention include a method of controlling a temperature of exhaust gas. The method includes: directing a flow of exhaust gas from a turbomachine to an exhaust assembly, the exhaust assembly including a nozzle, a mixing conduit in fluid communication with the nozzle, and at least one secondary inlet disposed around a periphery of the nozzle and extending between an exterior of the mixing conduit and an interior of the mixing conduit; moving a variable nozzle mechanism between i) a first position in which the mechanism is configured to close the at least one secondary inlet and ii) a second position in which the mechanism is configured to open the at least one secondary inlet to allow entry of an exterior gas into the mixing conduit and adjust a selected diameter of the nozzle.

Additional features and advantages are realized through the techniques of exemplary embodiments of the invention. Other embodiments and aspects of the invention are described in detail herein and are considered a part of the claimed invention. For a better understanding of the invention with advantages and features thereof, refer to the description and to the drawings.

### BRIEF DESCRIPTION OF THE DRAWINGS

FIG. 1 is a side view of a gas turbine assembly in accordance with an exemplary embodiment of the invention; and

FIG. 2 is a side perspective view of an exemplary embodiment of an exhaust system;

FIG. 3 is a side view of a portion of the exhaust system of FIG. 2;

FIG. 4 is a side cross-sectional view of a portion of the exhaust system of FIG. 2;

FIG. 5 is a front view of a rotatable member of the exhaust system of FIG. 2; and

FIG. 6 is a flow chart providing an exemplary method of controlling a temperature of thermal management of exhaust gas.

### DETAILED DESCRIPTION OF THE INVENTION

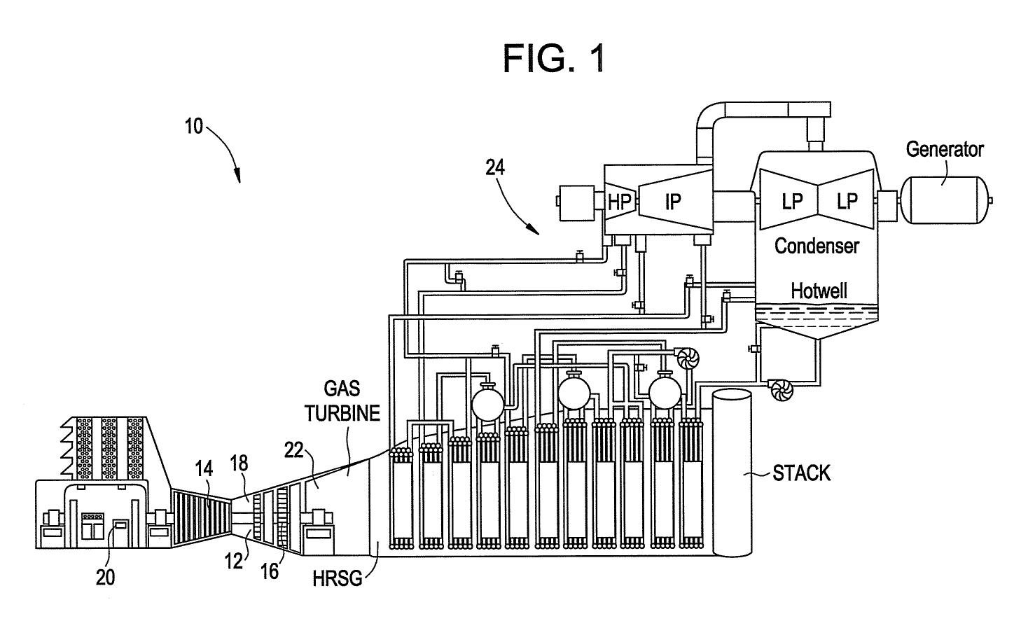

With reference to FIG. 1, a gas turbine assembly constructed in accordance with an exemplary embodiment of the invention is indicated generally at 10. The assembly 10 includes a rotor 12 attached to a compressor 14 and a power turbine 16. A combustion chamber 18 is in fluid communication with both the compressor 14 and the power turbine 16, and acts to ignite a fuel and air mixture to cause rotation of the power turbine 16 and the rotor 12. Rotation of the rotor 12 in turn powers, for example, a generator 20. Exhaust gas 22 is exhausted from the power turbine 16, and at least a portion thereof is guided to a heat recovery steam generator (HRSG) 24 that recovers heat from the hot exhaust gas 22 and produces steam that is usable in, for example, a steam turbine in an electrical generation system.

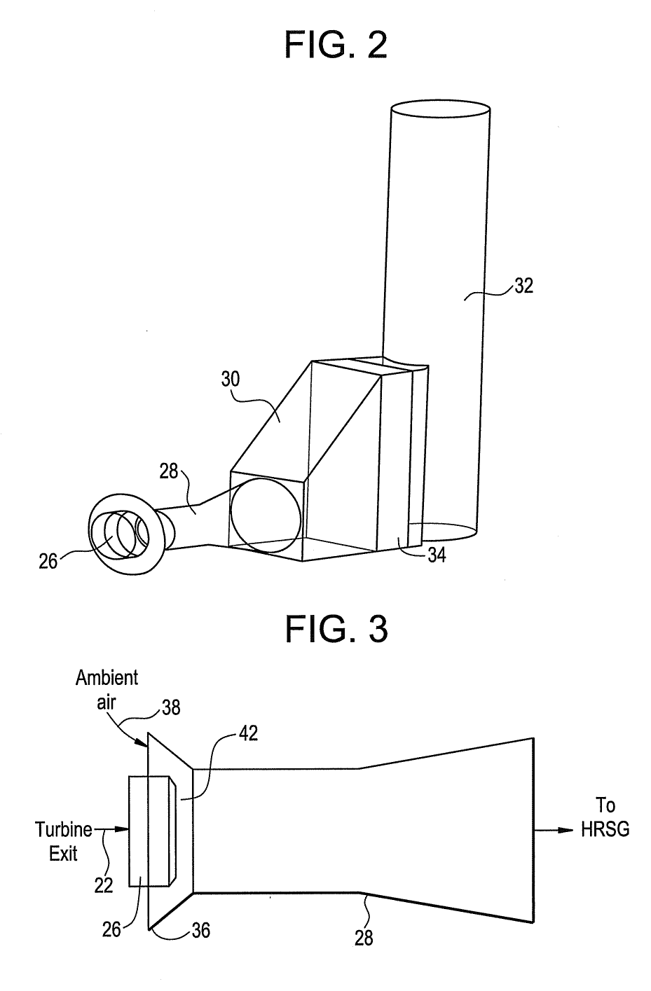

Referring to FIGS. 2 and 3, an exhaust system 25 for management of the temperature of the exhaust gas 22 is shown that is configured to be disposed in fluid communication with, for example, an exhaust ejector of the power turbine 16. The exhaust system 25 includes a nozzle 26 in fluid communication with a mixing duct 28 and a transition duct 30. Exhaust gas can be exhausted through the transition duct 30 to a stack 32 and/or the HRSG 24. In one embodiment, the exhaust gas 22 is directed through an exhaust processor such as HRSG tube bundles 34.

In one embodiment, one or more secondary inlets 36 are disposed and configured to allow an exterior gas such as the ambient air 38 or other cooling gases to enter the mixing duct 28 and cool the exhaust gas 22 prior to introducing the exhaust gas to the HRSG 24 or to the atmosphere. The mixing duct 28 is configured to urge the ambient air 38 into the mixing duct 28 via the one or more secondary inlets 36 by a suction effect. In one embodiment, a plurality of the secondary inlets 36 are positioned around the nozzle 26 and are generally symmetrically about a central axis 40 of the mixing duct 28. In one embodiment, the secondary inlets 36 are formed between a conically shaped inlet portion 42 of the mixing duct 28 and the nozzle 26. The number and configuration of the secondary inlets 36 are exemplary. The secondary inlets are configured to allow entry of ambient air or other cooling gases to temper the exhaust gas 22 at start-up, for example, to relieve or prevent thermal shock to the HRSG 24.

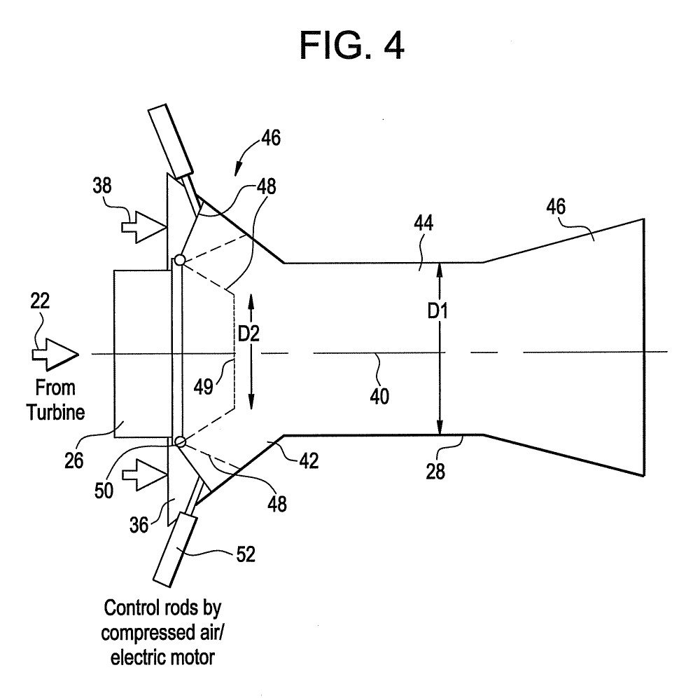

Referring to FIG. 4, the mixing duct 28 includes a mixing tube 44 and diffuser 46. In one embodiment, the mixing tube 44 is a generally cylindrical tube having an inner diameter “D1”, and the diffuser 46 is a generally conical tube in fluid communication with the mixing tube 44.

In one embodiment, the nozzle 26 includes a variable nozzle mechanism 46 for varying a diameter of the nozzle 22 and also varying an amount and flow rate of ambient air 38 or other exterior gas through the secondary inlets 36. The variable nozzle mechanism 46 includes a plurality of rotating members 48 disposed in selected locations around a periphery of the nozzle 26. In one embodiment, each rotating member 48 is rotatably connected to an associated peripheral member 50, such as a pivot pin, located at or near the periphery of the nozzle 26. In one embodiment, each of the rotatable members 48 extend from a periphery of the nozzle 26 and are connected to the peripheral members 50 so that each rotatable member 48 rotates about an axis that is perpendicular to the central axis 40. In one embodiment, the peripheral member 50 is one or more members 50 forming a ring at or near the nozzle 26 periphery.

One or more of the rotating members 48 are operably connected to an actuator 52 for moving the rotating members between a first position and a second position. Each actuator 52 is operably connected to a motor or other power source, such as a hydraulic, pneumatic or electric power source, to move the actuator(s) and cause the rotating members 48 to move between the first and the second position. In one embodiment, a biasing member such as a spring is included to bias the rotating members 48 toward the first or second position.

As referred to herein, the “first position” refers to a rotational position about the ring that causes the rotatable members 48 to at least substantially contact an interior surface of the conical portion 42. Also as referred to herein, the “second position” refers to any rotational position about the ring that is away from the first position and causes the opening of the secondary inlets 36 between the conical portion and the nozzle 26. In one embodiment, the second position is located so that a nozzle opening 49 is formed in the interior of the mixing duct 28. In the first position, the rotating members function as a gate to close the secondary inlets 36 and prevent ingress of ambient air 38 through the secondary inlets 36 during, for example, steady state operation. In the second position, the rotating members 48 form the nozzle opening 49 having a selected temperature and allow ambient air or other cooling gases to enter through the secondary inlets 36.

When the rotating members 48 are rotated toward the second position, the momentum of exhaust gas 22 through the nozzle 26 is utilized to pump ambient air 38 into the exhaust gas 22 to lower the temperature. The introduction of ambient air or other gases into the exhaust gas flow may be referred to herein as “entrainment”.

In one embodiment, when the rotating members are moved to the second position, they form a small diameter “D2” nozzle opening to create a pumping force for ambient air 38 to temper exhaust gas 22 at, for example, turbine start-up. In this embodiment, the diameter D2 is smaller than the diameter D1 of the mixing tube 44. In operation, exhaust gas 22 flows from the gas turbine though the nozzle 26 and the mechanism 46, and into the mixing tube 44. Due to the larger cross sectional area D1 of the mixing tube 44, the exhaust gas 22 expands and creates a region of relatively low pressure in the mixing tube 44. The low pressure creates a suction effect, drawing ambient air 38 into the mixing tube 44 through the one or more secondary inlets 36. In one embodiment, the diffuser 46 creates additional low pressure in the mixing tube 44 that increases the suction effect. The ambient air 36 mixes with the exhaust gas 22 in the mixing duct 28 and reduces the overall temperature of the exhaust gas/ambient air mixture.

In one embodiment, the rotating members 48 are rotated toward the second position to form the nozzle opening 49 having a selected diameter. In one embodiment, the selected diameter D2 is selected to be smaller than the diameter D1 of the mixing tube 44, and can be controlled to control an amount of suction and accordingly an amount of ambient air flow. Thus, in this manner, the temperature of the exhaust gas 22 through the mixing tube 44 can be controlled.

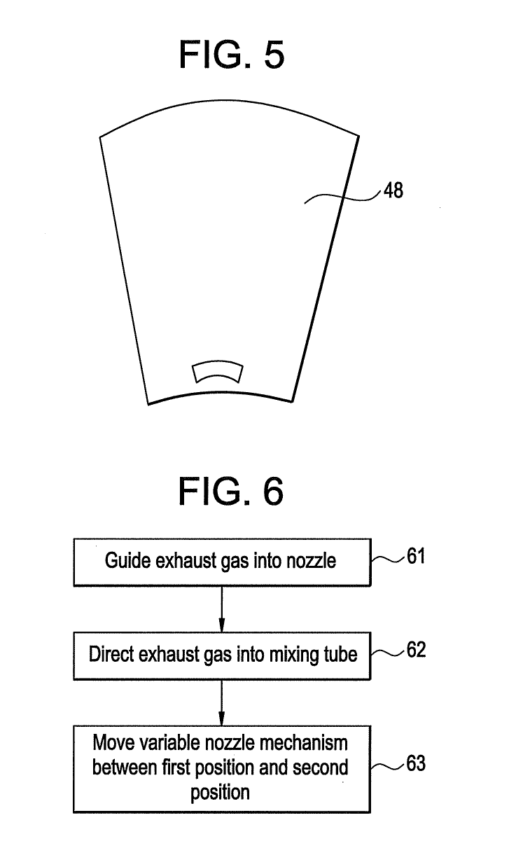

Referring to FIG. 5, the rotating members 48 are of any suitable size and shape to cooperate to form either the gate in the first position or a nozzle opening having the selected diameter. In one embodiment, the rotating members 36 each form a relatively wide and flat member such as a plurality of overlapping vanes or leaves. In this embodiment, each rotating member 48 has a relatively flat portion that extends generally parallel to the axis of rotation of the rotating member 48. The size and shape of the rotating members are not limited, and may be any size and shape suitable to cooperatively form a gate in the first position and a nozzle opening in the second position.

As discussed above, the secondary inlets 36 are configured to allow entry of ambient air 38 or other cooling gases to temper the exhaust gas 22 at start up, for example, to relieve or prevent thermal shock to the HRSG 24. In one embodiment, the rotating members 48 are rotated or maintained at the second position during startup to cool the exhaust gas 22 until the HRSG 24 components reach a running temperature, so that the HRSG 24 can be gradually and controllably brought up to running temperature. After all relevant components have been brought to running temperature, the rotating members 48 are rotated toward the first position to seal off the secondary inlets 36 and prevent further entry of ambient air 38.

FIG. 6 illustrates an exemplary method 60 for controlling temperature of an exhaust gas of a turbine or other apparatus. The method 60 includes one or more stages 61-63. In an exemplary embodiment, the method includes the execution of all of stages 61-63 in the order described. However, certain stages may be omitted, stages may be added, or the order of the stages changed. Although the method 60 is described in conjunction with the turbine assembly 10 and the exhaust system 25, the method 60 may be used in conjunction with any turbomachine or apparatus capable of exhausting high temperature gas.

In the first stage 61, exhaust gas 22 from the power turbine 16 is guided into the nozzle 26. The exhaust gas 22, in one embodiment, is emitted from the power turbine 16 during a start-up operation or during steady state operation.

In the second stage 62, the exhaust gas 22 is directed into the mixing tube 44. If the variable nozzle mechanism 46 is in the first or closed position, no ambient air 38 or other exterior gas enters into the mixing tube 44. If the mechanism 46 is in the second or open position, ambient air 38 or other exterior gas is drawn into the mixing tube 44 by a suction force dependent on the diameter D2 of the nozzle opening 49 formed by the rotatable members 48.

In the third stage 63, the variable nozzle mechanism 46 is moved, for example, via the actuator 52, between the first position and the second position. In one embodiment, the mechanism 46 is moved to or between any selected position to define or adjust a selected diameter D2.

For example, during turbine start-up processes, the mechanism 46 is moved to the second position via the actuator 52 to open the secondary inlets 36 and cool the exhaust gas 22 with the ambient air 38. The second position maybe adjusted to control the diameter D2 of the nozzle opening 49 to adjust the temperature accordingly. Upon transition to steady state operation, the mechanism 46 is moved to the first position via the actuator 52 to close the secondary inlets 36 and prevent entry of the ambient air 38.

Although the systems and methods described herein are provided in conjunction with gas turbines, any other suitable type of turbine, turbomachine or other device incorporating inlet and exhaust materials may be used. For example, the systems and methods described herein may be used with a steam turbine or a turbine including both gas and steam generation.

The system and method described herein provide numerous advantages over prior art systems. The system and method allows for relatively rapid start-up while avoiding potential thermal shock or other damage, and effective and precise control of exhaust gas temperature by controlling the volume to ambient air entering the exhaust system. Furthermore, the system and method prevent the entry of ambient air into the mixing duct during steady state operation, thereby decreasing backpressure and increasing efficiency, while allowing for control of exhaust gas temperature during startup to avoid thermal shock.

The capabilities of the embodiments disclosed herein can be implemented in software, firmware, hardware or some combination thereof As one example, one or more aspects of the embodiments disclosed can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the disclosed embodiments can be provided.

In general, this written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of exemplary embodiments of the invention if they have structural elements that do not differ from the literal language of the claims, or if they include equivalent structural elements with insubstantial differences from the literal language of the claims.

1. A system for thermal management of exhaust gas, the system comprising:
a nozzle configured to be disposed in fluid communication with an exhaust of a turbomachine;
a mixing conduit in fluid communication with the nozzle;
at least one secondary inlet disposed around a periphery of the nozzle and extending between an exterior of the mixing conduit and an interior of the mixing conduit;
a variable nozzle mechanism configured to be movable between i) a first position in which the mechanism is configured to close the at least one secondary inlet and ii) a second position in which the mechanism is configured to open the at least one secondary inlet and adjust a selected diameter of the nozzle; and
an actuator configured to move the variable nozzle mechanism between the first position and the second position.

2. The system of claim 1, wherein the variable nozzle mechanism includes a plurality of rotatable members disposed around the periphery of the nozzle and extending from the periphery of the nozzle.

3. The system of claim 2, wherein each of the plurality of rotatable members substantially contact an interior surface of the mixing conduit in the first position,

4. The system of claim 2, wherein the plurality of rotatable members overlap to form a nozzle opening having the selected diameter.

5. The system of claim 2, further comprising a plurality of peripheral members disposed at the periphery and forming a ring.

6. The system of claim 1, wherein each of the plurality of rotatable members are configured to rotate about a respective peripheral member along an axis that is perpendicular to a central axis of the mixing conduit.

7. The system of claim 1, wherein the mixing conduit includes a cylindrical mixing tube having an interior diameter greater than the diameter of the nozzle in the second position.

8. The system of claim 1, further comprising a biasing member configured to bias the variable nozzle mechanism toward the first position or the second position.

9. The system of claim 1, wherein the mixing conduit is in fluid communication with a heat recovery steam generator (HRSG).

10. The system of claim 1, wherein the turbomachine is a gas turbine.

11. A method of controlling a temperature of exhaust gas, the method comprising:
directing a flow of exhaust gas from a turbomachine to an exhaust assembly, the exhaust assembly including a nozzle, a mixing conduit in fluid communication with the nozzle, and at least one secondary inlet disposed around a periphery of the nozzle and extending between an exterior of the mixing conduit and an interior of the mixing conduit; and
moving a variable nozzle mechanism between i) a first position in which the mechanism is configured to close the at least one secondary inlet and ii) a second position in which the mechanism is configured to open the at least one secondary inlet to allow entry of an exterior gas into the mixing conduit and adjust a selected diameter of the nozzle.

12. The method of claim 11, wherein the exterior gas is selected from at least ambient air and a cooling gas.

13. The method of claim 11, wherein the selected diameter is less than an interior diameter of the mixing conduit.

14. The method of claim 11, wherein the variable nozzle mechanism is moved to the first position during a steady state operation of the turbomachine, and is moved to the second position during a start-up operation of the turbomachine

15. The method of claim 11, herein moving the variable nozzle to the second position includes creating a suction effect from the flow of exhaust gas and drawing the exterior gas into the mixing conduit

16. The method of claim 11, wherein the variable nozzle mechanism includes a plurality of rotatable members disposed around the periphery of the nozzle and extending from the periphery of the nozzle.

17. The method of claim 16, wherein moving the variable nozzle mechanism to the first position includes substantially contacting each of the plurality of rotatable members to an interior surface of the mixing conduit

18. The method of claim 16, wherein moving the variable nozzle mechanism to the second position include rotating and overlapping the plurality of rotatable members to form a nozzle opening having the selected diameter.

19. The method of claim 18, wherein the plurality of rotatable members are rotated about a respective peripheral member along an axis that is perpendicular to a central axis of the mixing conduit.

20. The method of claim 11, further comprising biasing the variable nozzle mechanism toward one of the first position and the second position.
